(19) United States
(12) Patent Application Publication
(10) Pub. No.: US 2025/0288160 A1
(43) Pub. Date: Sep. 18, 2025

(54) Bathtub or Seated Shower With Storage

(71) Applicant: AS America, Inc., Piscataway, NJ (US)

(72) Inventors: Matthew A. KUHNS, Canfield, OH (US); Christophe BUCHER, Hillsborough, NJ (US); Corey PETERSON, Bordentown, NJ (US); Ronald D. BARNDT, Bethlehem, PA (US)

(73) Assignee: AS America, Inc., Piscataway, NJ (US)

(21) Appl. No.: 19/081,065

(22) Filed: Mar. 17, 2025

Related U.S. Application Data
(60) Provisional application No. 63/566,669, filed on Mar. 18, 2024.

(51) Int. Cl. A47K 3/00; A47B 46/00; A47K 3/02; A47K 3/28; E05C 19/02

(52) U.S. Cl. CPC A47K 3/001; A47K 3/02; A47K 3/282; A47B 46/005; E05C 19/022

(57) ABSTRACT

A bathtub assembly and seated shower assembly with storage compartments are described. A bathtub may include a basin wall defining a water basin, an outer wall defining a side of the bathtub, and a first storage compartment formed in an interior space between the outer wall and the basin wall. A seated shower assembly may include a seat and a first storage compartment formed in an interior space between a front wall and a back wall and adjacent to a first side wall of the seat.

The disclosure relates generally to bathtubs and seated showers, and more specifically, to bathtubs and seated showers with built-in storage.

### BACKGROUND

From shampoo bottles, to towels, to children's bath toys, there are many items that take up storage space in a bathroom. Many people look to add storage space in their bathrooms. However, between the sink, toilet, bathtub, and shower, there is often limited space available to install extra shelving or cabinets that could provide more storage.

### SUMMARY

There is a need for storage solutions that are integrated into bathroom fixtures that can provide storage space without taking up the limited usable space in a bathroom. Bathtubs and seated showers described herein can meet this need by providing storage compartments in an internal space between the outer walls defining the side of the tub and the inner walls defining the water basin of the tub. By providing a bathtub with one or more integrated storage compartments, a person can store their bathroom products and other items without installing additional shelving or obtrusive cabinetry. The bathtubs described herein can allow a person to keep their bathroom products organized while maximizing usable space in their bathroom.

In some embodiments, a bathtub is provided, the bathtub comprising a basin wall defining a water basin; an outer wall defining a side of the bathtub; a first storage compartment formed in an interior space between the outer wall and the basin wall; and a first door disposed at a first location on the outer wall and providing access through the side of the bathtub to the first storage compartment.

In some embodiments, a bathtub may comprise a second storage compartment formed in the interior space between the outer wall and the basin wall. In some embodiments, a second storage compartment of a bathtub may be deeper than a first storage compartment. In some embodiments, a bathtub may comprise a second door disposed at a second location on an outer wall and provide access through the side of the bathtub to a second storage compartment.

In some embodiments, a first door of a bathtub may be configured to open by tilting vertically, and a second door of the bathtub may be configured to swing open horizontally. In some embodiments, a first location may be closer than a second location to a wet wall end of a bathtub.

In some embodiments, a first storage compartment may comprise a first drainage system. In some embodiments, a first drainage system may comprise a first elevated grate configured to allow water to pass underneath objects placed on top of the first elevated grate. In some embodiments, a first drainage system may comprise a water outlet configured to allow water to drain from inside a first compartment onto a floor adjacent the side of the bathtub.

In some embodiments, a first drainage system may comprise a first storage drainage pipe configured to direct water to drain from inside a first compartment and into a primary drain pipe of the water basin.

In some embodiments, a first storage compartment may comprise a ventilation system. In some embodiments, a first door may comprise an integrated basket. In some embodiments, a bathtub may comprise a removable storage basket sized and shaped to be removably stored in the first storage compartment.

In some embodiments, a first door may be attached to an outer wall by respective first hinges that are concealed behind the outer wall and the first door, such that the first hinge does not protrude beyond the side of the bathtub. In some embodiments, a bathtub may comprise a first push release latch configured to maintain a first door in a closed position and to allow the first door to be opened by pushing inward on the first door.

In some embodiments, a bathtub may comprise one or more of an acrylic, steel, cast iron, gel coat, sheet molding compound (SMC), fiberglass, ceramic, porcelain, or a composite.

In some embodiments, a seated shower is provided, the seated shower comprising a seat comprising a top surface, a bottom surface, a front wall, a back wall, a first side wall, and a second side wall, a first storage compartment formed in an interior space between the front wall and the back wall and adjacent to the first side wall; and a first door disposed at a first location on the first side wall and providing access from the outside of the seated shower to the first storage compartment.

In some embodiments, a seated shower may comprise a second storage compartment formed in an interior space between the front wall and the back wall and adjacent to the top surface of the seat. In some embodiments, a second storage compartment may be larger than a first storage compartment. In some embodiments, a seated shower may comprise a second door disposed at a top surface of the seat, providing access through the top surface of the seated shower to a second storage compartment. In some embodiments, a first door may be configured to swing open horizontally, and a second door may be configured to flip open vertically.

In some embodiments, a second storage compartment may comprise a drainage system. In some embodiments, a drainage system may comprise a water outlet configured to allow water to drain from inside a second compartment onto a floor adjacent to the front of the seated shower. In some embodiments, a floor of a second storage compartment may comprise a pair of opposing surfaces that each slope toward the water outlet. In some embodiments, a pair of opposing surfaces may slope to form a pair of opposite acute angles with respect to a laterally extending axis that runs parallel to a bottom edge of the seat.

In some embodiments, a first door may comprise an integrated drawer slidably disposed within the first storage compartment. In some embodiments, a seated shower may comprise a removable storage basket sized and shaped to be removably stored in the first storage compartment.

In some embodiments, a first door may be attached to the first side wall by respective first hinges that are concealed behind the first side wall and the first door, such that the first hinge does not protrude beyond the first side wall of the seated shower.

In some embodiments, a seated shower may comprise a first push release latch configured to maintain the first door in a closed position and to allow the first door to be opened by pushing on the first door.

In some embodiments, ta seated shower may comprise one or more of an acrylic, steel, cast iron, gel coat, SMC, fiberglass, ceramic, porcelain, or a composite.

In some embodiments, any one or more of the features or aspects of any of the embodiments recited above may be combined in whole or in part with one another, and/or may be combined in whole or in part with any other feature or aspect disclosed herein.

### BRIEF DESCRIPTION OF THE FIGURES

The invention will now be described, by way of example only, with reference to the accompanying drawings, summarized below. In the Figures, like reference numbers refer to like components unless stated herein to the contrary.

FIG. 1A and FIG. 1B show a bathtub assembly having storage compartments, in accordance with some embodiments herein.

FIG. 1C provides an underside view of a bathtub assembly having storage compartments, in accordance with some embodiments herein.

FIG. 2 shows a view of a bathtub storage compartment, in accordance with some embodiments herein.

FIG. 3 provides a sectional side of a storage compartment, in accordance with some embodiments herein.

FIG. 4A, FIG. 4B, and FIG. 4C provide views of a seated shower assembly, in accordance with some embodiments herein.

FIG. 4D and FIG. 4E provide front and side sectional views of a seated shower assembly, respectively, according to some embodiments.

### DETAILED DESCRIPTION

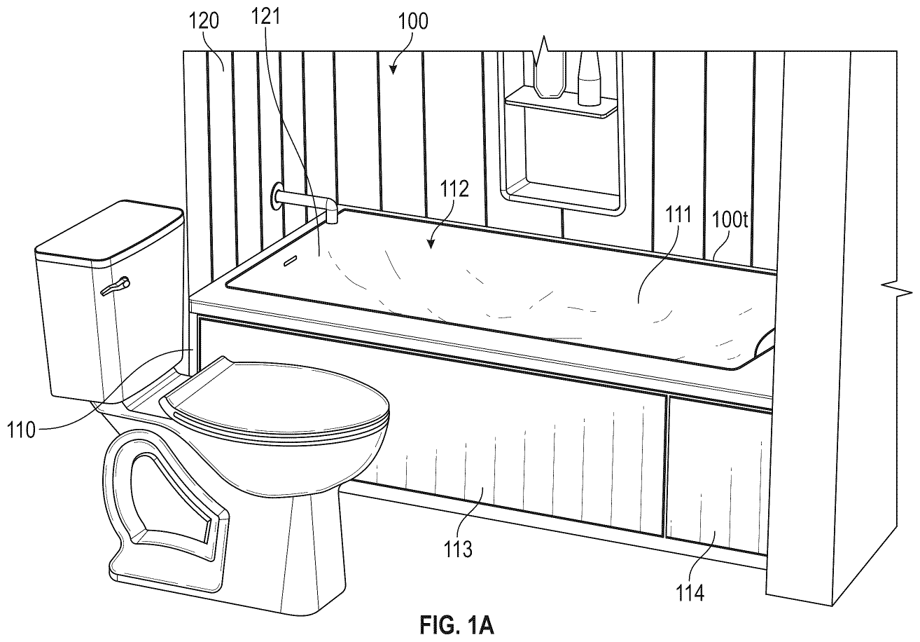

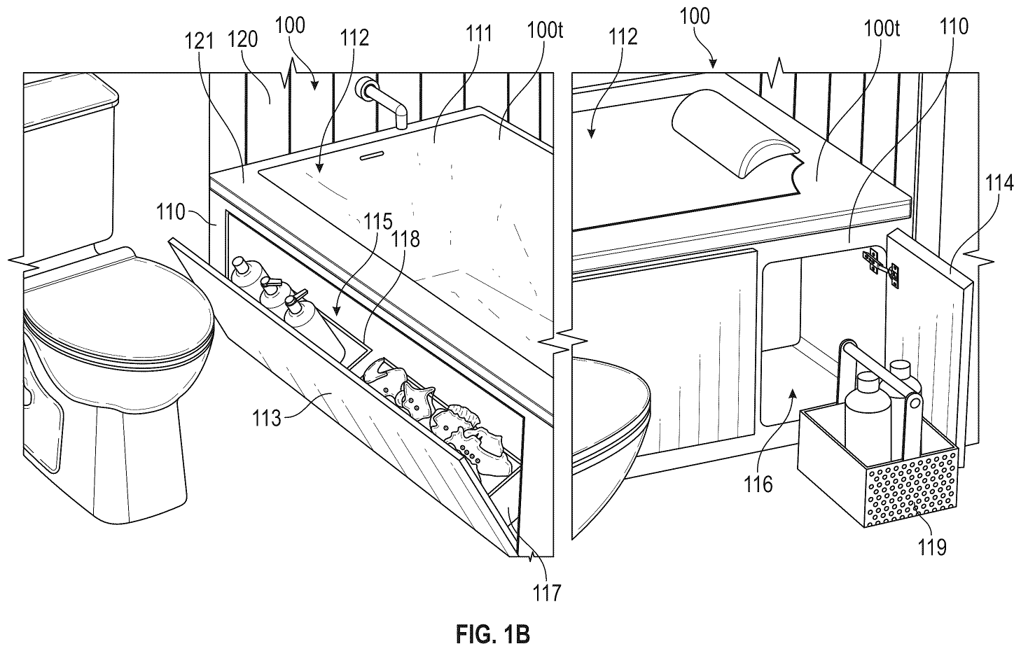

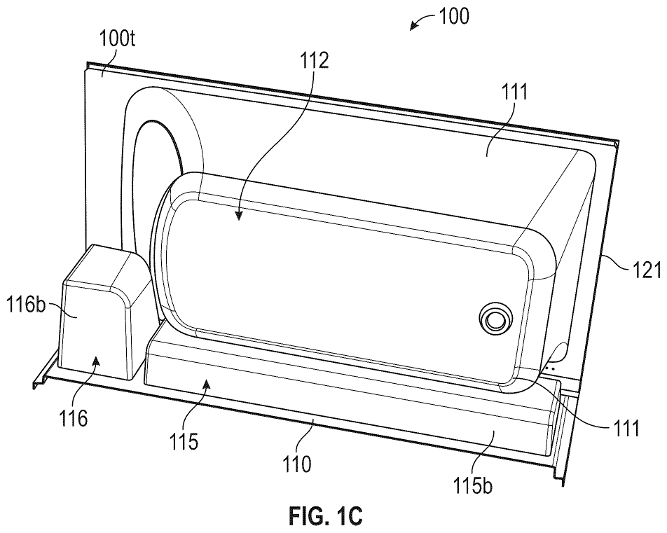

FIG. 1A and FIG. 1B provide views of bathtub assembly 100 installed in a bathroom. Bathtub assembly 100 may be comprise an apron tub or any other type of tub having outer wall 110 defining a side of tub 100t of bathtub assembly 100. Bathtub assembly 100 may be substantially rectangular as shown, or alternatively, it may be round, oval, a corner shape, or any other suitable shape. Tub portion 100t of bathtub assembly 100 may be made from acrylic, steel, cast iron, gel coat, SMC, fiberglass, ceramic, porcelain, a composite material, or combinations thereof. In some embodiments, bathtub assembly 100 may have a width of less than or equal to about 30 inches, about 32 inches, about 34 inches, or about 36 inches. In some embodiments, bathtub assembly 100 may have a width of greater than or equal to about 30 inches, about 32 inches, about 34 inches, or about 36 inches. In some embodiments, bathtub assembly 100 may have a length of less than or equal to about 55 inches, about 60 inches, about 65 inches, about 70 inches, or about 75 inches. In some embodiments, bathtub assembly 100 may have a length of greater than or equal to about 55 inches, about 60 inches, about 65 inches, about 70 inches, or about 75 inches. In some embodiments, bathtub assembly 100 may have a height of less than or equal to about 10 inches, about 12 inches, about 14 inches, about 16 inches, about 18 inches, about 20 inches, or about 22 inches. In some embodiments, bathtub assembly 100 may have a height of greater than or equal to about 10 inches, about 12 inches, about 14 inches, about 16 inches, about 18 inches, about 20 inches, or about 22 inches. In some embodiments, bathtub assembly 100 may be enclosed by a shower curtain. In some embodiments, bathtub assembly 100 may be enclosed by a glass door. In some embodiments, instead of a bathtub, any of the features described herein, including one or more storage compartments, may be built into a seated shower assembly.

In some embodiments, bathtub 100t includes basin wall 111 defining water basin 112 for one to bathe in. In some embodiments, basin 112 may have a drain. In some embodiments, basin 112 may be made from the same material(s) as one or more other components of bathtub 100t, or it may be made from different materials or combinations of materials. In some embodiments, basin 112 may have a minimum or maximum depth of less than or equal to about 10 inches, about 12 inches, about 14 inches, about 16 inches, about 18 inches, about 20 inches, or about 22 inches. In some embodiments, basin 112 may have a minimum or maximum depth of greater than or equal to about 10 inches, about 12 inches, about 14 inches, about 16 inches, about 18 inches, about 20 inches, or about 22 inches. In some embodiments, basin 112 may have a capacity of less than or equal to about 40 liters, about 50 liters, about 60 liters, about 70 liters, or about 80 liters. In some embodiments, basin 112 may have a capacity of greater than or equal to about 40 liters, about 50 liters, about 60 liters, about 70 liters, or about 80 liters.

In some embodiments, bathtub assembly 100 may have one or more storage compartments formed in an interior space between outer wall 110 and basin wall 111. Bathtub assembly 100 contains first storage compartment 115 configured to be opened/closed with door 113, and second storage component 116 configured to be opened/closed with door 114. While two storage compartments are shown, this embodiment is only exemplary. In some embodiments, bathtub assembly 100 may have less than or equal to 2, 3, 4, 5, or 6 storage compartments formed between outer wall 110 and basin wall 111. In some embodiments, bathtub assembly 100 may have greater than or equal to 1, 2, 3, 4, 5, or 6 storage compartments formed between outer wall 110 and basin wall 111. Storage compartments may have doors disposed at different locations at outer wall 110, such as doors 113 and 114. In some embodiments, door 113 and/or 114 may have hardware installed inside the storage compartments as opposed to external hardware on the doors/outer wall 110 so that a person will not scrape their leg on hardware when stepping over outer wall 110 to get into basin 112. In some embodiments, storage compartment doors may include a shallow groove or lip at an upper edge or side edge for a user to grip when pulling a door open without the need for a handle protruding from the door. In some embodiments, doors 113 and/or 114 may include a push release mechanism configured to maintain the door in a closed position and to allow the door to be opened by pushing inward on the door. In some embodiments, a push release latch may comprise a spring-loaded magnetic push latch. In some embodiments, a push release latch may comprise a detent latch which may be configured to hold a door closed without the use of a magnet, such as a spring-loaded ball, roller, or grab latch.

As shown, door 113 is configured to open by tilting the door outward from a door top edge so as to access storage compartment 115 from the top. In other embodiments, door 113 may be configured to open by tilting it outward from a door bottom edge so as to access storage compartment 115 from below. Door 113 comprises trays or baskets 117 and 118 configured to hold bath toys or soaps/shampoos, as shown. Trays or baskets may comprise openings or perforations configured to allow water to drain therefrom. Trays or baskets may be integral with a door (permanently attached to), or may be removably attached to a door. In yet other embodiments, a first storage compartment may have a door that opens by swinging horizontally. Door 114 is disposed at a second location and provides access through a side of bathtub assembly 100 to second storage compartment 116. Basket 119 is configured to fit within compartment 116. Door 114 is configured to open by swinging horizontally. In other embodiments, a door enclosing a second compartment may be configured to open by tilting outward from a top or bottom edge. In some embodiments, one or more storage compartments may also include slide drawers, cabinets, shelving, caddies, baskets, and/or other features. In some embodiments, storage compartments may be made from the same material(s) as bathtub 100t, or they may be made from different materials or combinations of materials. Tilting outward is performed in a vertical, or up/down, direction.

In some embodiments, first storage compartment 115 having outward tilting door 113, may be positioned closer to wet wall 120 than second storage compartment 116 having horizontally swinging door 114. A wet wall, e.g. wall 120, may be a wall of a bathroom and/or a bathtub assembly that comprises plumbing hookups, such that a showerhead and/or tub spout may be affixed to plumbing positioned behind wet wall 120. Additionally, other fixtures and plumbing in the bathroom, such as toilets and/or sinks, may be installed at a same wet wall 120 next to or near bathtub assembly 100. An end of bathtub assembly 100 adjacent to wet wall 120 may be referred to as “wet wall end” 121 of bathtub assembly 100. As such, in some embodiments, tilting door 113 may be disposed at a first location that is closer to tub wet wall end 121 than a second location of swinging door 114. Providing outward vertical tilting compartment door 113 near wet wall end 121 allows one to open door 113, and access associated compartment 115 even when a toilet is installed at wet wall 120 adjacent to bathtub 100t as shown.

FIG. 1C provides an underside view of bathtub 100t, showing an exemplary configuration of storage compartments 115 and 116 around basin 112. As shown, storage compartments 115 and 116 may occupy internal space between basin wall 111 and outer wall 110 of bathtub 100t. This allows for otherwise unusable space within a bathtub to be used for storage. In some embodiments, second compartment 116 with horizontally swinging door 114 may be deeper than first compartment 115 with the vertically tilting door 113. Storage compartment 115 contains bottom floor 115b, and storage compartment 116 contains bottom floor 116b.

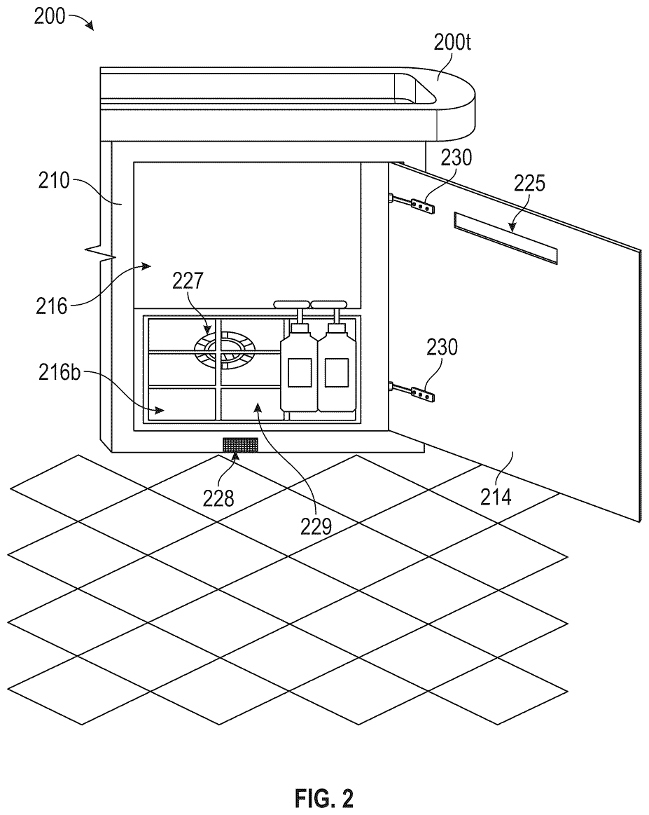

FIG. 2 shows a portion of bathtub assembly 200, according to some embodiments. A view of exemplary storage compartment 216 having horizontally swinging door 214 is shown. Door 214 includes ventilation system 225 configured to allow air to flow within ant through storage compartment 216. Ventilation system 225 contains a plurality of slits; alternatively, it may comprise a vent positioned over an opening in door 214. Ventilation system 225 is shown positioned towards a top of door 214; alternatively, it may be positioned towards a center, a bottom, or a side of door 214. Door 214 may comprise a plurality of (e.g. 2 or more) ventilation systems. Ventilation system 225 may help prevent accumulation of mold or mildew within storage compartment 216. In some embodiments, door 214 may comprise a watertight seal formed with outer wall 210 configured to prevent water from the bathtub from dripping into storage compartment 216. Alternatively, in some embodiments, door 214 may be configured such that when the door is shut, a top of door 214 does not directly abut outer wall 210. This configuration may create a gap between door 214 and tub 200t to allow air to enter storage compartment 216 from the top, to provide for ventilation.

Storage compartment 216 further comprises drainage system 227, positioned in bottom floor 216b of compartment 216, configured to allow any water that might inadvertently enter storage compartment 216 to exit. Drainage system 227 may include a storage drainage pipe (not shown) which may be connected to a primary drain of tub 200t such that water may drain from storage compartment 216 into a primary drain. In some embodiments, as shown, bottom floor 216b of compartment 216 may be in flow communication with outlet 228 such that small amounts of water that might enter storage compartment 216 can drain onto a floor adjacent to the side of bathtub 200t and evaporate therefrom. In some embodiments, bottom floor 216b of storage compartment 216 may be sloped toward drainage system 227 and/or outlet 228. In some embodiments, as shown, storage compartment 216 comprises elevated grate 229, configured such that wet items stored or positioned thereon are allowed to drip towards bottom floor 216b. Hardware 230 attached to door 214 is installed internally towards compartment 216. Hardware 230 may comprise concealed cabinet hinges as shown, or may comprise push a release latch, a detent, a magnetic assembly, etc. In some embodiments, hardware 230 may include a childproof lock feature. Door 214 may also include one or more baskets, shelves, or trays integrated with or removably attached to an inner side thereof. Any features shown or described with respect to a compartment with a tilting door may also be present in a storage compartment with a swinging door, and vice versa. The term “integrated” may generally mean “permanently attached” or an “integral part thereof”.

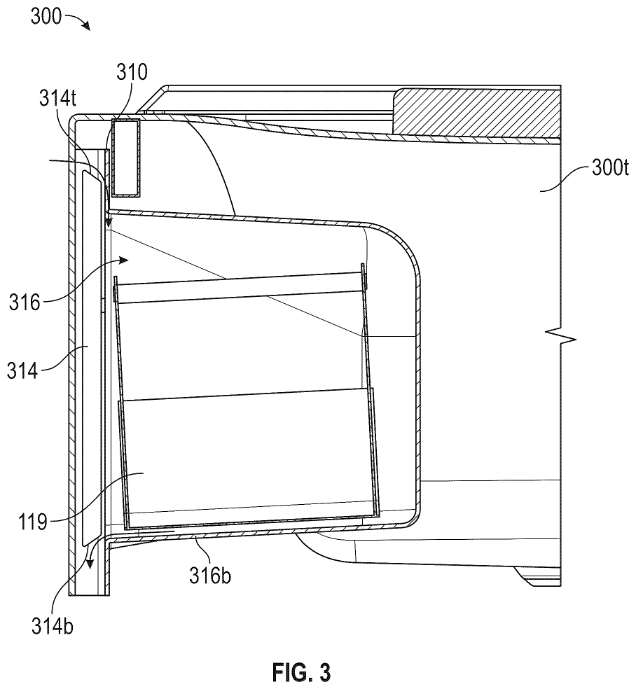

FIG. 3 provides a sectional view of tub assembly 300, according to some embodiments. Bottom floor 316b of storage compartment 316 is downwardly, outwardly sloped towards outer wall 310 of tub 300t, such that residual water that might enter storage compartment 316 will be directed toward outer wall 310. Door 314 is configured such that when it is shut, top 314t and bottom 314b of door 314 do not completely abut outer wall 310, allowing air to flow around door 314 into and out of compartment 316. Further, residual water that might enter compartment 316 may exit through a gap at door bottom 314b. In other embodiments, floor 316b may be sloped toward a drainage system of storage compartment 316 as described in FIG. 2. Storage basket 119 is shown positioned in compartment 316. Door 314 comprises angled top 314t and angled bottom 314b configured to allow one to grab upper or lower end 314t/314b to open door 314.

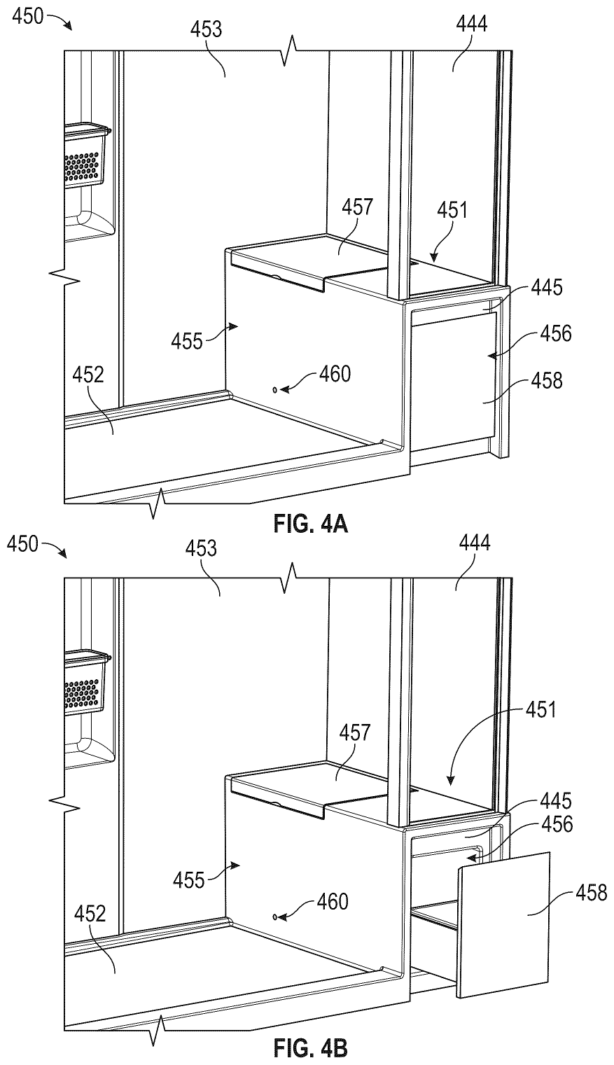

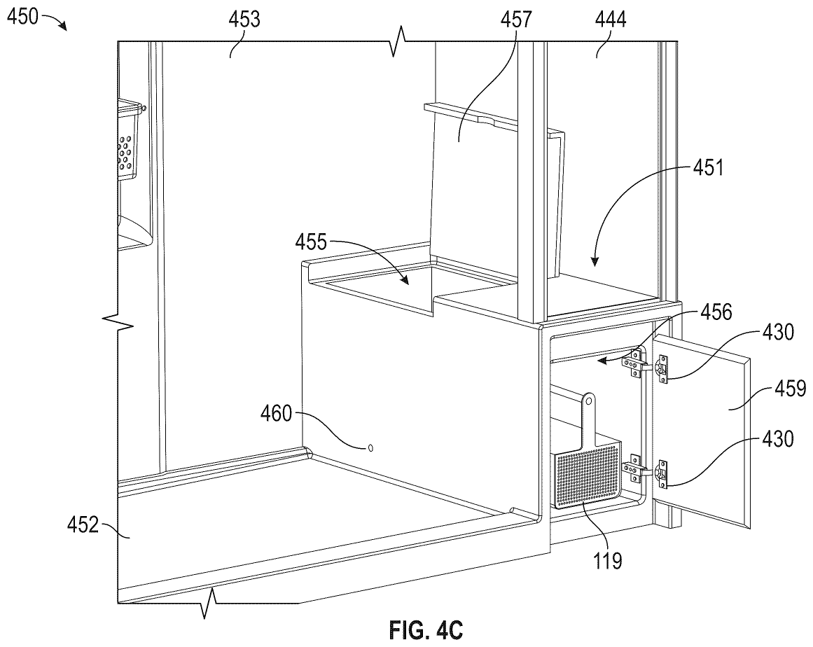

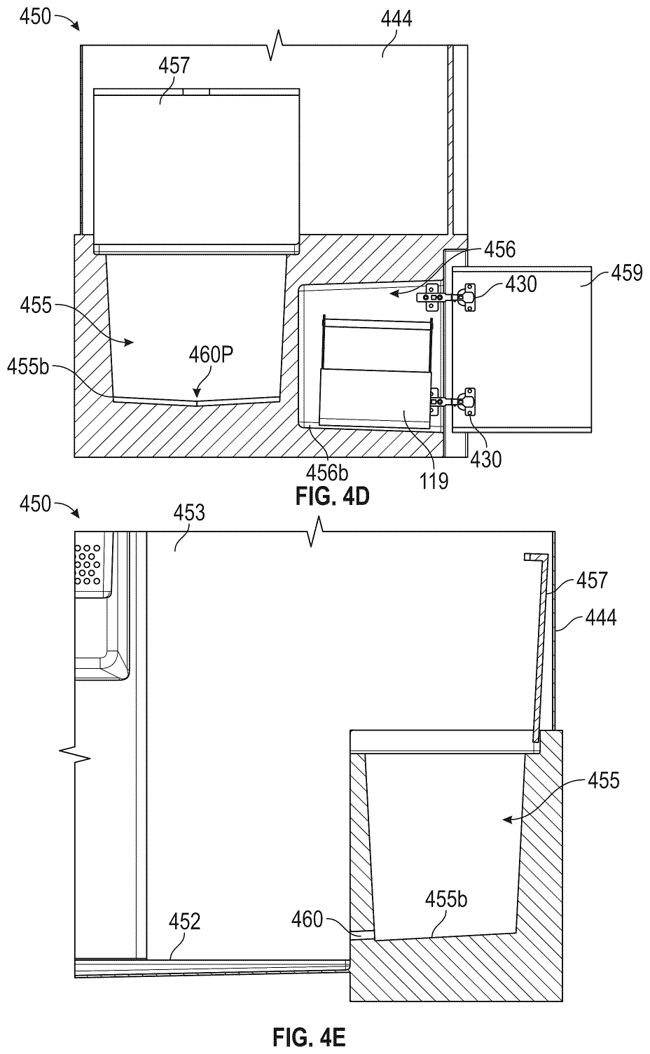

FIG. 4A and FIG. 4B provide views of seated shower assembly 450, according to some embodiments. Seated shower assembly 450 comprises shower seat 451, configured for one to sit on during a shower. Shower seat 451 is positioned adjacent shower base 452 and coupled to inner shower walls 453 and 444. Shower seat 451 comprises door 457, configured to lift upward from front to back to provide access to first storage compartment 455. Shower seat 451 also comprises door 458, configured to slidably open to provide access to second storage compartment 456. Door 458 is positioned at outer side wall 445. Seat 451 comprises outlet 460 positioned towards shower base 452. Outlet 460, positioned at a front wall of seat 451, is configured to allow water that might enter compartments 455 and/or 456 to exit onto shower base 452 and towards a shower drain (not shown). Shower base 452 slopes downward away from shower seat 451 towards a drain. Additionally, or alternatively, shower seat 451 may comprise a drainage system as described above for a tub assembly. Door 458 comprises an angled upper edge configured for one to grab in order to slidably open it.

FIG. 4C provides a view of another version of seated shower assembly 450, according to some embodiments. Door 457 is shown in an open position, having been vertically lifted from front to back to provide access to first storage compartment 455. Door 459 is also shown in an open position, providing access to second storage compartment 456. Compartment 456 is shown storing basket 119. Door 459 is configured to open horizontally. Door 459 is coupled to shower seat 451 with hardware 430, comprising hinge assemblies. Door 459 also comprises angled edges configured for one to grab to open it.

FIG. 4D and FIG. 4E provide front and side sectional views, respectively, of seated shower assembly 450, according to some embodiments. Door 457 is shown in an open position, providing access to first storage compartment 455. Horizontal swinging door 459 is also shown in an open position, providing access to second storage compartment 456. Bottom floor 455b of storage compartment 455 is sloped downward from shower wall 444 towards outlet 460 and towards shower base 452. Bottom floor 455b is also sloped downward from outer edges of storage compartment 455 towards point 460p at which outlet 460 is positioned. Accordingly, bottom floor 455b is sloped downward towards outlet 460 from back to front and from outer edges to a low point at which outlet 460 is positioned, configured to allow any water that might enter compartment 455 to exit through outlet 460 onto shower base 452. Likewise, bottom floor 456b of second storage compartment 456 is sloped downward from an inner to an outer point such that any water that might enter compartment 456 may exit through a gap under door 459 onto a bathroom floor where it may evaporate.

Described herein are bathtub assemblies and seated shower assemblies with one or more storage compartments integrated into an internal space between the outer walls defining a side of the tub and inner walls defining the water basin of the tub. As described herein, a tub may have one or more storage compartments that are located in a space behind a side of the tub, between the outer wall of the tub and the internal basin wall of the tub. A first storage compartment may be accessible via a first door on the outer wall of the tub, wherein the first door can open by tilting vertically in some embodiments or by swinging horizontally in other embodiments. A second storage compartment may also be accessible via a second door on the outer wall of the tub, wherein the second door can also open by tilting vertically or swinging horizontally. A first compartment may be located proximate to a wet wall of the bathtub and may be shallower in depth, thereby facilitating use of the first compartment even when the bathtub is installed nearby to an adjacent toilet on the same wall as the wet wall of the bathtub. A second compartment may be located at the opposite end of the bathtub from the first compartment and may be deeper in depth. A swinging door of the second compartment may facilitate storage of larger items in the deeper compartment, including a removable storage basket sized to fit therein. In some embodiments, instead of a bathtub, any of the features described herein, including one or more storage compartments, may be present in a seated shower assembly. In some embodiments, a floor of a storage compartment in a bathtub assembly and/or seated shower assembly can be angled so as to facilitate the drainage of residual water from within the storage compartment.

Following are some non-limiting embodiments of the disclosure.

In a first embodiment, disclosed is a bathtub assembly comprising a bathtub having a basin wall defining a water basin; an outer wall defining a side of the bathtub; a first storage compartment formed at an interior space between the outer wall and the basin wall; and a first door positioned at the outer wall, the first door is configured to open and close to provide access to and to enclose the first storage compartment, respectively.

In a second embodiment, disclosed is a bathtub assembly according to the first embodiment, comprising a second storage compartment formed in the interior space between the outer wall and the basin wall. In a third embodiment, disclosed is a bathtub assembly according to embodiments 1 or 2, wherein the second storage compartment is deeper than the first storage compartment. In a fourth embodiment, disclosed is a bathtub assembly according to any of the preceding embodiments, comprising a second door positioned at the outer wall, the second door configured to open and close to provide access to and to enclose the second storage compartment, respectively. In a fifth embodiment, disclosed is a bathtub assembly according to any of the preceding embodiments, wherein the first storage component is configured to be positioned closer to a bathroom wet wall than is the second storage component.

In a sixth embodiment, disclosed is a bathtub assembly according to any of the preceding embodiments, wherein the first door is configured to open by tilting outward vertically, and the second door is configured to swing open horizontally.

In a seventh embodiment, disclosed is a bathtub assembly according to any of the preceding embodiments, wherein the first storage compartment comprises a first drainage system. In an eighth embodiment, disclosed is a bathtub assembly according to any of the preceding embodiments, wherein the first drainage system comprises a first elevated grate configured to allow water to pass underneath objects placed on top of the first elevated grate. In a ninth embodiment, disclosed is a bathtub assembly according to any of the preceding embodiments, wherein the first drainage system comprises a water outlet configured to allow water to drain from inside the first compartment onto a floor adjacent the side of the bathtub. In a tenth embodiment, disclosed is a bathtub assembly according to any of the preceding embodiments, wherein the first drainage system comprises a first storage drainage pipe configured to direct water from inside the first compartment and into a primary drain pipe of the bathtub assembly.

In an eleventh embodiment, disclosed is a bathtub assembly according to any of the preceding embodiments, wherein the first storage compartment comprises a ventilation system. In a twelfth embodiment, disclosed is a bathtub assembly according to any of the preceding embodiments, wherein the first door comprises an integrated tray or basket. In a thirteenth embodiment, disclosed is a bathtub assembly according to any of the preceding embodiments, further comprising a removable storage basket sized and shaped to be removably stored in the first storage compartment.

In a fourteenth embodiment, disclosed is a bathtub according to any of the preceding embodiments, wherein the first door is attached to the outer wall by respective first hinges that are concealed behind the outer wall and the first door, such that the first hinge does not protrude beyond the side of the bathtub. Hardware comprising hinges may be configured to not be visible when a door is in a closed position. In a fifteenth embodiment, disclosed is a bathtub assembly according to any of the preceding embodiments, further comprising a first push release latch configured to maintain the first door in a closed position and to allow the first door to be opened by pushing inward on the first door.

In a sixteenth embodiment, disclosed is a bathtub assembly according to any of the preceding embodiments, wherein the bathtub comprises one or more of acrylic, steel, cast iron, gel coat, SMC, fiberglass, ceramic, porcelain, and/or a composite.

Following is another set of non-limiting embodiments of the disclosure.

In a first embodiment, disclosed is a seated shower assembly comprising a seat comprising a top surface, a bottom surface, a front wall, a back wall, a first side wall (outer wall), and a second side wall (inner wall), a first storage compartment formed at an interior space between the front wall and the back wall and adjacent to the first side wall; and a first door positioned at the first side wall and configured to open and close to provide access to and to enclose the first storage compartment, respectively. In a second embodiment, disclosed is a seated shower of the first embodiment, further comprising a second storage compartment formed at an interior space between the front wall and the back wall and adjacent to the top surface of the seat.

In a third embodiment, disclosed is a seated shower assembly of embodiments 1 or 2, wherein the second storage compartment is larger than the first storage compartment. In a fourth embodiment, disclosed is a seated shower assembly of any of the preceding embodiments, comprising a second door positioned at the top surface of the seat and configured to provide access through the top surface of the seat to the second storage compartment.

In a fifth embodiment, disclosed is a seated shower assembly of any of the preceding embodiments, wherein the first door is configured to swing open horizontally, and the second door is configured to rotate open vertically.

In a sixth embodiment, disclosed is a seated shower assembly of any of the preceding embodiments, wherein the second storage compartment comprises a drainage system. In a seventh embodiment, disclosed is a seated shower assembly of any of the preceding embodiments, wherein the drainage system comprises a water outlet configured to allow water to drain from inside the second compartment onto a shower base adjacent to the front of the seat. In an eighth embodiment, disclosed is a seated shower assembly of any of the preceding embodiments, wherein a floor of the second storage compartment comprises a pair of opposing surfaces that each slope toward the water outlet. In a ninth embodiment, disclosed is a seated shower assembly of any of the preceding embodiments, wherein the pair of opposing surfaces slope to form a pair of opposite acute angles with respect to a laterally extending axis that runs parallel to a bottom edge of the seat.

In a tenth embodiment, disclosed is a seated shower assembly of any of the preceding embodiments, wherein the first door comprises an integrated drawer slidably disposed within the first storage compartment. In an eleventh embodiment, disclosed is a seated shower assembly of any of the preceding embodiments, comprising a removable storage basket sized and shaped to be removably stored in the first storage compartment.

In a twelfth embodiment, disclosed is a seated shower assembly of any of the preceding embodiments, wherein the first door is attached to the first side wall by respective first hinges that are concealed behind the first side wall and the first door, such that the first hinge does not protrude beyond the first side wall of the sea. In a thirteenth embodiment, disclosed is a seated shower assembly according to any of the preceding embodiments, comprising a first push release latch configured to maintain the first door in a closed position and to allow the first door to be opened by pushing on the first door.

In a fourteenth embodiment, disclosed is a seated shower assembly of any of the preceding embodiments, wherein the seated shower comprises one or more of acrylic, steel, cast iron, gel coat, SMC, fiberglass, ceramic, porcelain, and/or a composite.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A bathtub assembly comprising
a bathtub having a basin wall defining a water basin;
an outer wall defining a side of the bathtub;
a first storage compartment formed at an interior space between the outer wall and the basin wall; and
a first door positioned at the outer wall, the first door configured to open and close to provide access to and to enclose the first storage compartment, respectively.

2. The bathtub assembly according to claim 1, comprising a second storage compartment formed at the interior space between the outer wall and the basin wall, and a second door positioned at the outer wall, the second door configured to open and close to provide access to and to enclose the second storage compartment, respectively.

3. The bathtub assembly according to claim 2, wherein the first door is configured to open by tilting outward vertically, and the first storage component is configured to be positioned closer to a bathroom wet wall than is the second storage component.

4. The bathtub assembly according to claim 2, wherein the first door is configured to open by tilting outward vertically, and the second door is configured to swing open horizontally.

5. The bathtub assembly according to claim 1, wherein the first storage compartment comprises a first drainage system.

6. The bathtub assembly according to claim 5, wherein the first drainage system comprises a water outlet configured to allow water to drain from inside the first compartment onto a floor adjacent the side of the bathtub.

7. The bathtub assembly according to claim 5, wherein the first drainage system comprises a first storage drainage pipe configured to direct water from inside the first compartment and into a primary drain pipe of the bathtub assembly.

8. The bathtub assembly according to claim 1, wherein the first storage compartment comprises a ventilation system.

9. The bathtub assembly according to claim 1, wherein the first door comprises an integrated tray or basket.

10. The bathtub assembly according to claim 1, comprising a first push release latch configured to maintain the first door in a closed position and to allow the first door to be opened by pushing inward on the first door.

11. A seated shower assembly comprising
a seat comprising a top surface, a bottom surface, a front wall, a back wall, a first side wall, and a second side wall,
a first storage compartment formed at an interior space between the front wall and the back wall and adjacent to the first side wall; and
a first door positioned at the first side wall and configured to open and close to provide access to and to enclose the first storage compartment, respectively.

12. The seated shower assembly according to claim 11, comprising a second storage compartment formed at an interior space between the front wall and the back wall and accessible through the top surface of the seat.

13. The seated shower assembly according to claim 12, wherein the second storage compartment is larger than the first storage compartment.

14. The seated shower according to claim 12, comprising a second door positioned at the top surface of the seat and configured to provide access through the seat top surface to the second storage compartment.

15. The seated shower assembly according to claim 14, wherein the first door is configured to swing open horizontally, and the second door is configured to rotate open vertically.

16. The seated shower assembly according to claim 12, wherein the second storage compartment comprises a drainage system.

17. The seated shower assembly according to claim 16, wherein the drainage system comprises a water outlet configured to allow water to drain from inside the second compartment onto a shower base adjacent to the seat front.

18. The seated shower assembly according to claim 17, wherein a floor of the second storage compartment comprises a pair of opposing surfaces that each slope toward the water outlet.

19. The seated shower assembly according to claim 11, wherein the first door comprises an integrated drawer slidably disposed within the first storage compartment.

20. The seated shower of claim 11, comprising a first push release latch configured to maintain the first door in a closed position and to allow the first door to be opened by pushing on the first door.
